(19) United States
(12) Patent Application Publication
(10) Pub. No.: US 2012/0069895 A1
(43) Pub. Date: Mar. 22, 2012

(54) High Quality Video Encoder

(76) Inventor: David Frederique Blum, (US)

(21) Appl. No.: 12/884,263

(22) Filed: Sep. 17, 2010

(51) Int. Cl. H04N 7/26

(52) U.S. Cl. 375/240.03; 375/E07.139

(57) ABSTRACT

A computerized method for encoding and decoding video comprising: dividing a video frame into macro-blocks; Re-size the video frame into a lower resolution (“resized frame”).

Divide the resized video frame into macro-blocks
Encode the resized frame with video encoder.
The video include a set of motion compensation algorithms that are connected to the same motion estimation block.
Find the optimal motion compensation algorithm for each macro-block from a set of motion compensation algorithms. The chosen motion estimation algorithm for each macro-block gives the minimal error compared with the reference resized frame.
Resizing the output macro-block of the chosen motion compensation algorithm to the original frame size and subtract it from the original macro-block.
Encoding the result with a still image encoder.

The image encoder can be a jpeg encoder or jpeg2000 encoder, for example. Performing a two stage rate control process, the first rate control phase work on the video encoder scope, a second rate control phase work on the image encoder scope, The data received from the two mentioned above independent rate control processes are transmitted to a master a rate control processor that set the quantization factor for each rate control process. Eventually, the master rate control give two dimension quantization factors to the video encoder and image encoder respectively.

According to the present embodiments allows for dynamic switching between pairs of two dimensional decimation and interpolation algorithms.

### FIELD AND BACKGROUND OF THE INVENTION

The present invention relates to video data and more specifically to methods and system of coding, decoding, compressing, and transmitting video data in efficient manner as possible. Most video compression is lossy compression; it operates on the premise that much of the data present before compression are not necessary for achieving good perceptual quality. For example, DVD-Video use a video coding standard called MPEG-2 that can compress around two hours of video data by 15 to 30 times, while still producing a video quality that is generally considered high-quality for standard-definition video. Video compression is a tradeoff between computer disk space, video quality, and the cost of hardware required to decompress the video in a reasonable time. However, if the video is over compressed in a lossy manner, visible (and sometimes distracting) compression artifact can appear.

Video compression typically operates on square-shaped groups of neighboring pixels, often called macro-blocks. These pixel groups or blocks of pixels are compared from one frame to the next and the video compression codec (encode/decode scheme) sends only the “residual frame differences” within those blocks. This works extremely well if the video has no motion. A still frame of text, for example, can be repeated with very little transmitted data. In areas of video with more motion, more pixels change from one frame to the next. When more pixels change, the video compression scheme must send more data to keep up with the larger number of pixels that are changing. If the video content includes an explosion, flames, a flock of thousands of birds, or any other image with a great deal of high-frequency detail, the quality will decrease, or the variable bitrate must be increased to render this added information with the same level of detail.

The programming provider has control over the amount of video compression applied to their video programming before it is sent to their distribution system. DVDs, Blu-ray discs, and HD DVDs have video compression applied during their mastering process, though Blu-ray and HD DVD have enough disc capacity that most compression applied in these formats is light, when compared to such examples as most video streamed on the internet, or taken on a cellphone. Software used for storing video on hard drives or various optical disc formats will often have a lower image quality, although not in all cases. High-bitrate video codecs with little or no compression exist for video post-production work, but create very large files and are thus almost never used for the distribution of finished videos. Once excessive lossy video compression compromises image quality, it is impossible to restore the image to its original quality.

The present application relates to a new video codec that work simultaneously into two different way, one as video encoder and the other as a still image encoder.

### SUMMARY OF THE INVENTION

According to one aspect of the present invention there is provided a computerized method for encoding video compression:

choose from a library of spatial decimation and interpolation filters Algorithms, the spatial decimation and interpolation algorithm pair that satisfy the following method: resizing the original frame to a lower resolution, and than to encode the resulted video frame by a video encoder. The compressed video frame will be transmitted as input bit stream, simultaneously, the same encoded frame will be processed by a video decoder and undergo spatial interpolation in order to be subtracted from the original input frame. The result is called reconstructed error, the spatial decimation/interpolation algorithm pair that give the lower reconstructed error are chosen for each frame or for each macro-block. The reconstructed error is encoded with an image encoder and the result as an input bit stream.

The above described process include the following steps:

Receive an uncompressed video frame.

Re-size the video frame into a lower resolution (“re-sized frame”).

Divide the resized video frame into macro-blocks.

Encode the resized frame with video encoder.

The video include a set of motion compensation algorithms that are connected to the same motion estimation block.

Find the optimal motion compensation algorithm for each macro-block from a set of motion compensation algorithms. The chosen motion estimation algorithm for each macro-block gives the minimal error compared with the reference resized frame.

Resizing the output macro-block of the chosen motion compensation algorithm to the original frame size and subtract it from the original macro-block.

Encoding the result with a still image encoder.

The image encoder can be a jpeg encoder or jpeg2000 encoder, for example.

Performing a two stage rate control process, the first rate control phase work on the video encoder scope, a second rate control phase work on the image encoder scope, The data received from the two mentioned above independent rate control processes are transmitted to a master a rate control processor that set the quantization factor for each rate control process. The master rate control give two dimension quantization factors.

An embodiment may comprise finding settings for the minimal error motion compensation algorithm which settings further minimize the error.

In an embodiment, the settings comprise a pixel precision setting. An embodiment may comprise setting an overall rate control for a region of macro-blocks as a function of the two rate controls which are best settings for the individual macro-blocks within the region.

An embodiment may comprise setting a global control rate algorithm by operating a first control rate algorithms work on the video encoder scope and a second rate control work on the image encoder scope and providing the two dimensional quantization providing the best results at macro block level and a control rate algorithm providing the best results at frame level.

In an embodiment, finding an optimal spatial decimation/interpolation filter algorithm pair, comprises of running each one of a plurality of the spatial decimation/interpolation filter algorithm pairs on the macro-block, measuring an error for each pair and selecting the pair giving the smallest error.

An embodiment may comprise carrying out motion searches by comparing blocks of a maximum size of 8×8 pixels in succeeding frames.

An embodiment may comprise adding an identification of the minimal error motion estimation compensation pair used to encode each macro-block to encoded video, the identification being usable by a corresponding decoder to select the corresponding motion compensation algorithm to decode the respective macro-block

A second aspect of the present invention refer to a computerized method for decoding video. The video having been encoded per macro-block by finding for each macro-block a minimal motion compensation algorithm which gives a minimal error, encoding each macro-block using the corresponding motion compensation algorithm and embedding into the video an identification of the corresponding motion compensation algorithm, the decoding comprising extracting from the encoded video the identification and selecting a motion compensation algorithm for a respective macro-block according to the identification, there with decoding the macro-block

According to a third aspect of the present invention refer to an encoder apparatus for encoding video frames, comprising of:

A macro-block unit for dividing incoming frames into macro-blocks;

An optimization unit enable finding for each macro-block a minimal error motion compensation algorithms that encodes and decodes a respective macro-block with minimal error;

The video decoder apparatus may comprise an extraction unit for extracting information related to the optimal motion compensation algorithm used with each macro-block and a decoding unit for decoding each frame by macro-blocks, using the motion compensation algorithm of the respectively identified motion compensation algorithm for each macro-block

A computerized method of a further aspect of the present invention relate to video encoding process that may comprise:

Receiving an uncompressed video frame.

Resizing the video frame into a lower resolution (“resized frame”).

Dividing the resized video frame into macro-blocks

Encoding the resized frame with video encoder.

The video include a set of motion compensation algorithms that are connected to the same motion estimation block.

Finding the optimal motion compensation algorithm for each macro-block from a set of motion compensation algorithms. The chosen motion estimation algorithm for each macro-block gives the minimal error compared with the reference resized frame.

Resizing the output macro-block of the chosen motion compensation algorithm to the original frame size and subtract it from the original macro-block.

Encoding the result with a still image encoder.

The image encoder can be a jpeg encoder or jpeg2000 encoder, for example.

Performing a two stage rate control process, the first rate control phase work on the video encoder scope, a second rate control phase work on the image encoder scope, The data received from the two mentioned above independent rate control processes are transmitted to a master a rate control processor that set the quantization factor for each rate control process. Eventually, the master rate control give two dimension quantization factors.

Unless otherwise defined, all technical and scientific terms used herein have the same meaning as commonly understood by one of ordinary skill in the art to which this invention belongs. The materials, methods, and examples provided herein are illustrative only and not intended to be limiting.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Implementation of the method and/or system of embodiments of the invention can involve performing or completing selected tasks manually, automatically, or a combination thereof.

Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

The invention herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 a simplified diagram illustrating a simplified flow chart of operation of an encoder device according to a first embodiment of the present invention;

FIG. 2 a simplified schematic diagram illustrating an encoder for encoding video frames according to an embodiment of the present invention;

FIG. 3 a simplified schematic diagram illustrating an encoder for encoding video frames by macro-blocks according to an embodiment of the present invention;

FIG. 4 a simplified schematic diagram illustrating a decoder for decoding video frames by macro-blocks that have been encoded by the encoder of FIG. 2;

FIG. 5 a simplified diagram illustrating two phase rate control according to an embodiment of the present invention;

FIG. 6 a simplified diagram showing the two stage encoding, according to an embodiment of the present invention;

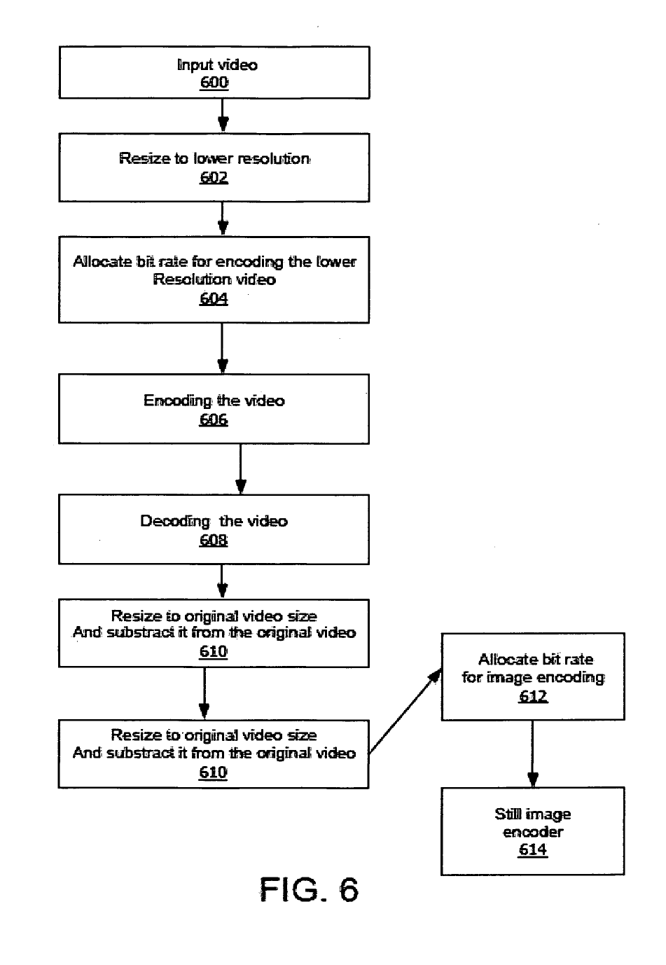

FIG. 7 shows in greater detail a part of the architecture of the encoder in which a set of motion compensation algorithms are tested for individual macro-blocks, in which two phase rate control run concurrently each one receiving static information and send a factor quantization output to the master rate control. finally the master rate control device distribute the total amount of quantization between the video encoder process and the image encoder process as needed, according to embodiments of the present invention;

FIG. 8 shows in schematic form available motion compensation algorithms decision, according to an embodiment of the present invention;

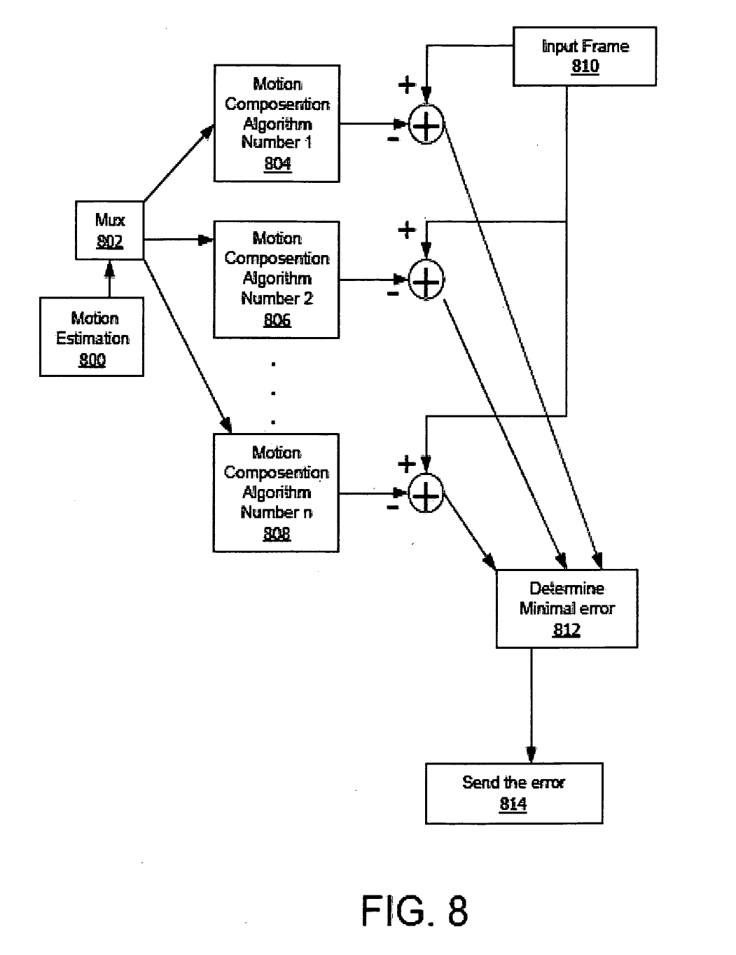

### DESCRIPTION OF THE PREFERRED EMBODIMENTS

The present embodiments comprise a device and method for video encoding. More particularly, the present embodiments relate to a device and method for multiple motion compensation algorithm that run simultaneously in video encoding, find the optimal motion compensation algorithm from a set of motion compensation algorithms in video encoding, the present embodiment relates to encoding simultaneously the video data both within an video encoder and within an image encoder, the present embodiment relate to two stage rate control and a two dimension quantization factor deliver from a special Master decision rate control A device and method according to the present embodiments, the present embodiment comprise a set of spatial decimation interpolation algorithm pair, find the optimal decimation/interpolation filter algorithm pair in video encoding. The present embodiments may provide a device and method for two concurrent rate control algorithm one operate into a video encoding and the other one operate into still image encoding, the two rate control work at frame level and/or macro-block level, and may find the optimal two dimensional quantization factor depending on distortion result in video encoding and image encoding. As will be explained in greater detail below, the present embodiments may perform a resizing to lower resolution of the video and encoding the result at much lower processing requirement. The present embodiments may be used to provide a video codec.

A motion compensation algorithm is selected dynamically for encoding individual macro-blocks of an image. The selection is made by using concurrently multiple motion compensation algorithms to encode the macro-block also we can using the same motion compensation algorithm with different settings. An error is found in each case between the source macro-block and the set of reconstructed macro-blocks from the set of motion compensation algorithms that run concurrently and choosing the motion compensation algorithm that produces the smallest error is selected for that macro-block As a further criterion the motion compensation algorithm for which the result is achieved with the smallest difference from the resized source macro-block is to be chosen. The decoder has all of the motion compensation algorithms used by the encoder and information is supplied from the encoder telling the decoder which motion compensation algorithm to use for which macro-block

The motion estimation with the set of motion compensation algorithms are used with the spatial decimate video input frame, because the motion estimation with a set of motion compensation algorithms are running on spatial decimate input frame, they save a large amount of cpu usage. Because the motion compensation algorithms is selected, the encoding and decoding may be dynamically matched. An improvement which may result is particularly noticeable on high definition television screens.

The two stage rate control is useful, particularly for Internet delivery of video. The present embodiments allow two rate control to run concurrently at the frame resolution and/or macro block resolution. There are two dimensional rate control process, one of the rate control operate into intra or inter frame, the second one operate all the time on the inter frame and quantize the error between the original frame or the original macro-block and the spatial interpolation of the optimal motion compensation algorithm output for each macro-block The rate control is able to provides either scalar or matrix quantization per frame or macro-block in order to deliver the desired rate. The frame resolution rate control is in turn built from rate control that operates at the macro block resolution and delivers scalar quantization or matrix quantization or rate control that operates at the .frame resolution and delivers scalar quantization or matrix quantization

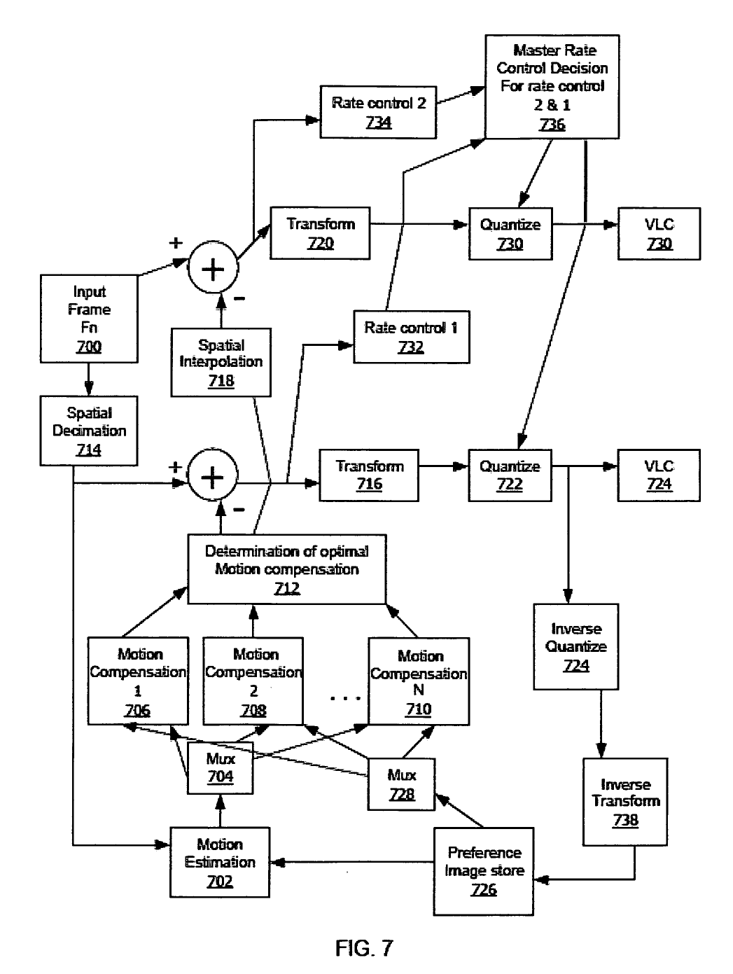

FIG. 7, which is discussed in greater detail below, illustrates an exemplary procedure for the two stage rate control processes with a Master rate control decision that deliver a two dimension quantization over a frame and over a macro-block The procedure may use two rate control algorithms and dynamically select the appropriate quantization both for the inter/intra frame and both for the residual image frame as follows:

For each of the two rate control algorithm (block 732 and block 734) in FIG. 7, the following procedure is carried out:

1) Estimate the rate distortion characteristics of the Frame or macro-block based on a) rate distortion statistics, b) GOP length and c) a Virtual Buffer Model management arrangement. Send the quantization factor of each rate control process (732 & 734) to the Master (2 (rate control device (736 The Master rate control (736) distribute the available quantization between the two (3 quantizer (722 & 730), The master rate control device distribute the quantization as needed, this distribution depends on the distortion factor of each rate control (732 & (734.

3) Finally, encoded the intra/inter frame and the residual frame using the selected two dimensional quantization rate control process.

In block 732 of FIG. 7 different kinds of rate control processes can be used, for example those that work at frame resolution and those that work at macro-block resolution compete with each other to see which produces the best results in a given conditions. A frame can be quantized by several rate control algorithm that work at macro-block resolution or the frame can be quantized by a rate control that work at frame resolution.

In block 734 of FIG. 7 Different kinds of rate control, for example those that work at frame resolution and those that work at macro block resolution compete with each other to see which produces the best results in a given conditions. A frame can be quantized by several rate control algorithm that work at macro-block resolution or the frame can be quantized by a rate control that work at frame resolution.

Estimating of the rate distortion and the quantization factor characteristics of the Frame or macro-block may be based on a) rate distortion statistics, b) GOP length and c) a Virtual Buffer Model management arrangement for the master rate control algorithms (736). Some rate control methods may operate at frame resolution. Other rate control methods may operate at macro block resolution. Yet other rate control methods may use scalar quantization, and others may operate on the basis of matrix quantization. Various such methods may be used concurrently and the system may choose the best one based on the achieved distortion level.

The two rate control (block 732 and 734 of FIG. 7) own their own virtual buffer model management and rate distortion, the block 736 of FIG. 7 own the real virtual buffer need to stream all the output data (724 & 730) at said bit rate and at said distortion.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

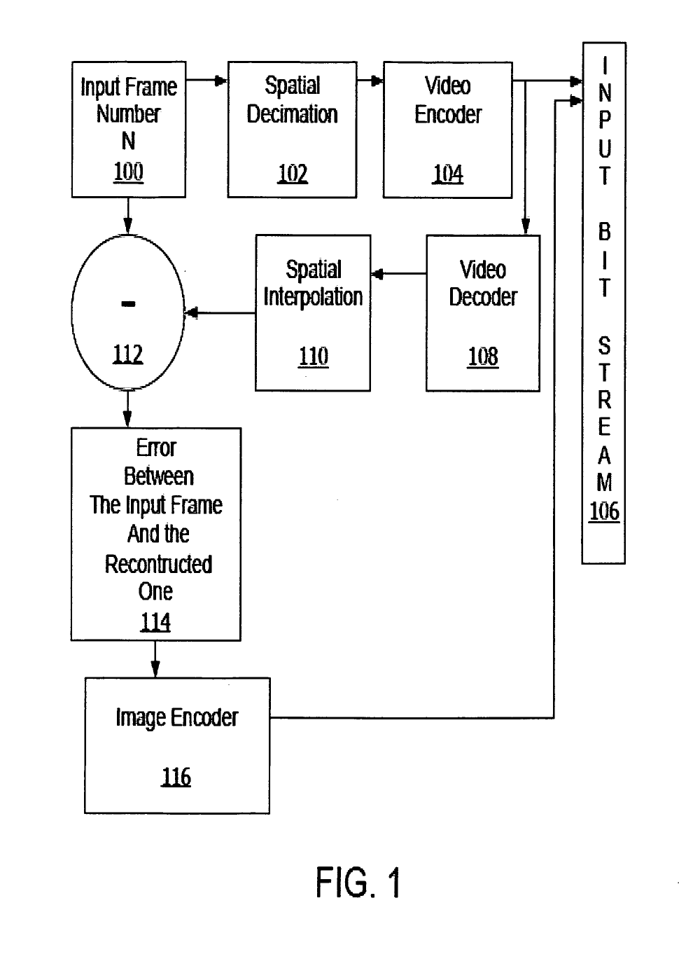

Reference is now made to FIG. 1 which is a simplified flow chart showing a computerized method for encoding video. The method involves resizing a video frame to a lower resolution (102), the resize frame to lower resolution will be name “LRF” that mean “Lower Resolution Frame” that is the output of block (102), then encode the “LRF” (104) and store the result for stream it (106), then take the encoded “LRF” and decode it (108), the result of the decoded “LRF” (108) is then resizing to the original frame size (110), we will called this resizing file “RF” that mean Reconstructed Frame, subtract the original Frame (100) by the “RF” (114) and then used an image encoder or an video encoder to encoded it (116), the result is stream with the encoded “LRF” (106).

The idea is that we can always perform an better video compression by splitting the encoding process into two stage, the first stage his to encoded the lower resolution frame by a video codec, the result is called “Encoded Lower Resolution Frame”, and then to correct the artifact that can be blockiness artifact, flickering artifact, resizing process artifact, or any other artifact done by the process, we decoded the “Encoded Lower Resolution Frame” and resize it to the original frame size, subtract it from the original frame and then encoded it with an image encoder or an video encoder, this part hold all the details and artifact correction need for retrieve the original image.

The video encoder can be one of the following:

H.264

MPEG-4 AVC

x264

Nero Digital

Quick Time

DivX Pro Codec

VP6, VP6-E, VP6, VP7, VP8: Proprietary high definition video compression formats and codecs developed by On2 Technologies

VP8 has been made open source by Google under the name ‘“libvpx”’ or ‘“VP8 codec library”’.

WMV (Windows Media Video): Microsoft's family of proprietary video codec designs including WMV 7, WMV 8, and WMV 9. The latest generation of WMV is standardized by SMPTE as the VC-1 standard.

The image encoder can be one of the following:

jpeg

Motion-jpeg

jpeg-2000

however we can also encoded the block 114 of FIG. 1 with an video encoder instead of an image encoder.

This method can correct the well known blockinees artifact, this method also allow to disable the deblocking filter that work in standard video encoder.

We introduce a new point of view for encoding video data stream.

Resizing the input frame to a lower resolution, the resized frame is called “Low Resolution Frame”. This process is done for each new input video frame.

Encode the “Low Resolution Frame” with a video encoder and store the result for the purpose of further streaming it.

Decode the “Low Resolution Frame” and then resize it to the original frame size, subtract the result from the original frame which result in the error frame artifact.

Encode the frame artifact error by an image encoder or a video encoder.

The new encoded video frame is the composition of the encoded “Low Resolution Frame” by a video encoder and the encoded error frame artifact by the image encoder or the video encoder.

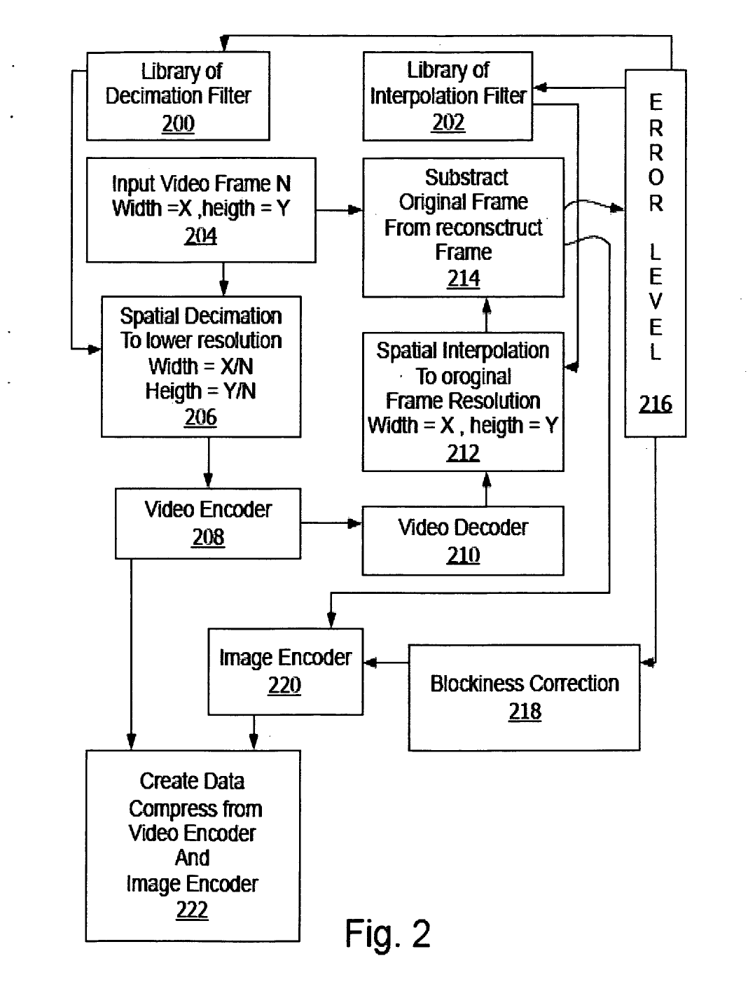

Reference is now made to FIG. 2, which shows a video encoder apparatus used for encoding video frames. An image size can be changed in several ways.

The easiest way of doubling its size is nearest-neighbor interpolation, replacing every pixel with four pixels of the same color:

The resulting image is larger than the original, and preserves all the original detail, but has undesirable Jaggies/jaggedness. Other scaling methods are better at preserving smooth contours in the image. For example, bi-linear interpolation.

Linear (or bi-linear, in two dimensions) interpolation is typically better than the nearest-neighbor system for changing the size of an image, but causes some undesirable softening of details and can still be somewhat jagged. Better scaling methods include bi-cubic interpolation.

The system included a library of several decimation algorithm filter (see block 200 into FIG. 2), and a library of several interpolation filter (see block 202 into FIG. 2), The following is a partial list of different two dimensional interpolation and decimation algorithms that may be considered in the present embodiments:

Some of the algorithm are:

Pixel art scaling algorithms.

Bi-cubic interpolation.

Bi-linear interpolation.

Lanczos re-sampling.

Spline interpolation.

Seam carving.

Super-sampling.

An error level module (see block 216 from FIG. 2), extracts or reads identification information relating to the minimal error decimation and interpolation algorithm pair of algorithms used with each macro-block or frame.

Encoding (208) and decoding (210) according to the present embodiments allows dynamic switching between pairs of two dimensional decimation algorithm and two dimensional interpolation algorithms to deal effectively with rapidly changing situations in the video. The error level done by block 216 of FIG. 2 give to the blockiness correction needed.

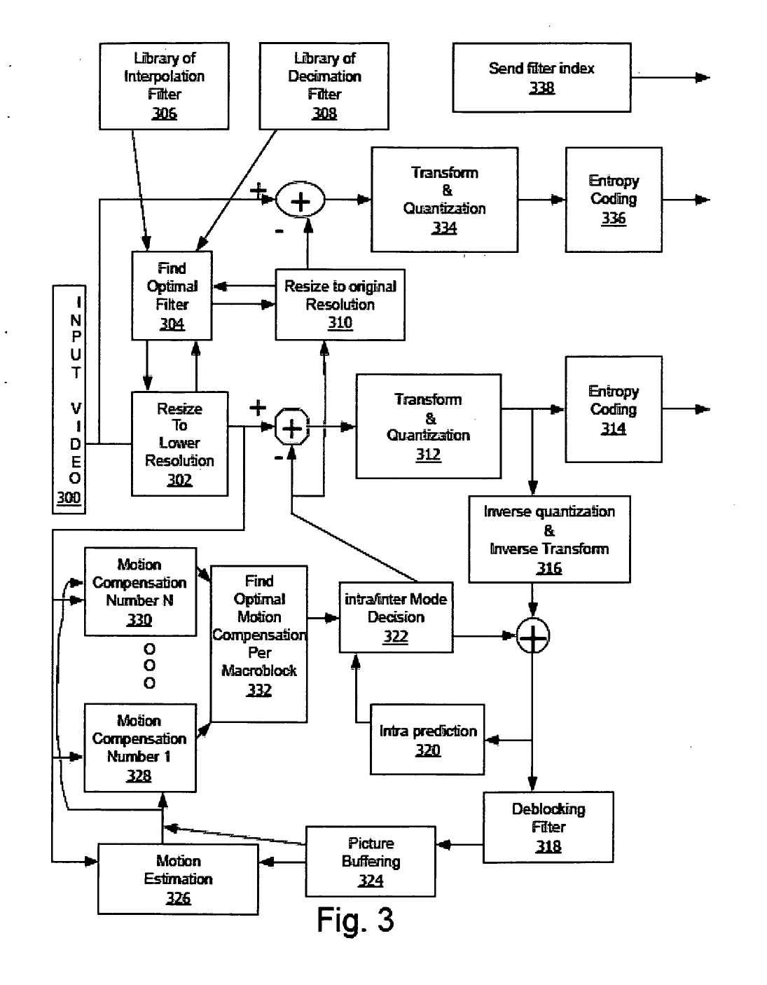

Reference is now made to FIG. 3, which is the corresponding encoder apparatus, the video encoder includes a set of motion compensation algorithms (see block 328 of FIG. 3 and block 330 of FIG. 3),

The following is a partial list of different motion compensation algorithms that may be considered in the present embodiments:

Block motion compensation

Variable block-size motion compensation

Overlapped block motion compensation

Quarter Pixel (QPel) and Half Pixel motion compensation

Fixed Size Block-Matching (FSBM)

Variable Size Block-Matching (VSBM)

Object based block-matching motion compensation

Fixed Size Block-Matching (FSBM)

Variable Size Block-Matching (VSBM)

The output of the motion estimation block (see block 326 FIG. 3), is then processed simultaneously by a set of motion compensation algorithms (328) (330). The set of motion compensation algorithms can be different algorithms or the set can be the same algorithm but with different settings. The optimal motion compensation algorithm is dynamically selected for each macro-block or for each frame, by finding the motion compensation algorithm that provides minimal motion prediction error (332). The motion prediction error is done by subtracting each of the motion compensation result (328) (330) with the reference frame (output of block 302), and this is done pixel by pixel.

Each motion compensation algorithm (see blocks 330 and 328 of FIG. 3) is a different algorithm of motion compensation or the same algorithm with different settings. The idea is to find the good prediction that will enable us to reconstruct the video frame as good as possible. We can look at this process as several mode prediction, the number of mode prediction is equal to the number of motion compensation algorithms, the point is that we never know which of the prediction give the best result, so we try all of them. this method will be name by us as “a multiple prediction for motion vectors”.

Block 304 of FIG. 3 is the block that responsible to find the optimal pair of two dimensional interpolation and decimation algorithm for each frame or macro block, this process is done dynamically for each new frame or each new macro-block

At each frame or macro-block, the block 304 of FIG. 3 upload the select two dimensional decimation and interpolation filter from the library (see block 306 and 308 of FIG. 3), this blocks contains all the possible two dimensional decimation and interpolation algorithm.

For each macro-block or frame we update the block 338 of FIG. 3 with the corresponding interpolation filter algorithm that we selected, the block 338 of FIG. 3 store it and send it with the output stream.

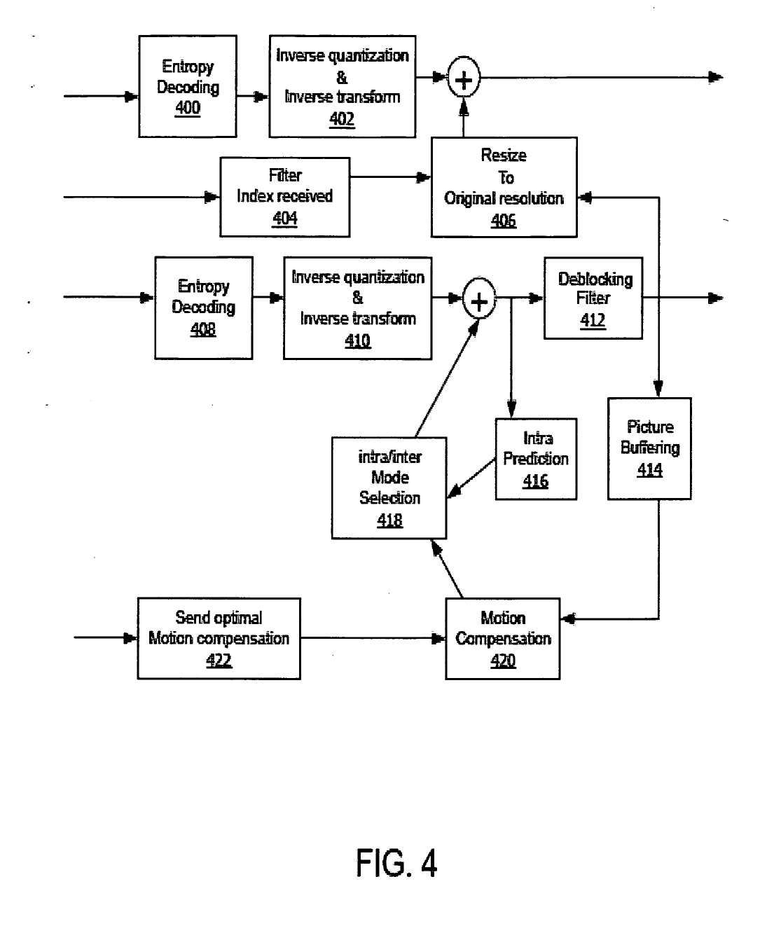

Reference is now made to FIG. 4, which describes the corresponding decoder apparatus which receives the frame as encoded by the apparatus of FIG. 3. The video decoder apparatus includes an extraction unit (422) that extracts or reads identification information relating to the minimal error motion compensation algorithm used with each macro-block or each frame and a decoding unit. The decoding unit which is constituted of blocks: 408 410 412 418 416 414 FIG. 4, decodes each frame or macro-blocks, using the motion compensation algorithm that belongs to the motion compensation identified, which is obtained from a database of the decoding options available. Encoding and decoding according to the present embodiments allows for dynamic switching between motion compensation algorithms to deal effectively with rapidly changing situations in the video.

The decoder is able to switch between different motion compensation algorithms based on information sent by the encoder.

The video decoder apparatus includes An extraction unit (404) that extracts or reads identification information relating to the minimal error two dimensional interpolation algorithm used with each macro-block or each frame and a decoding unit. The decoding unit is constituted of blocks: 406, 402, 400 FIG. 4, which decode each frame or macro-block, using the two dimensional interpolation algorithm that belongs to the two dimensional interpolation algorithm identified, which is obtained from a database of the decoding options available.

Encoding and decoding according to the present embodiments allows dynamic switching between two dimensional interpolation algorithms to deal effectively with rapidly changing situations in the video.

The decoder is able to switch between different motion compensation algorithms based on information sent by the encoder.

The decoder is able to switch between different types of two dimensional interpolation algorithms and motion compensation algorithms based on information sent by the encoder.

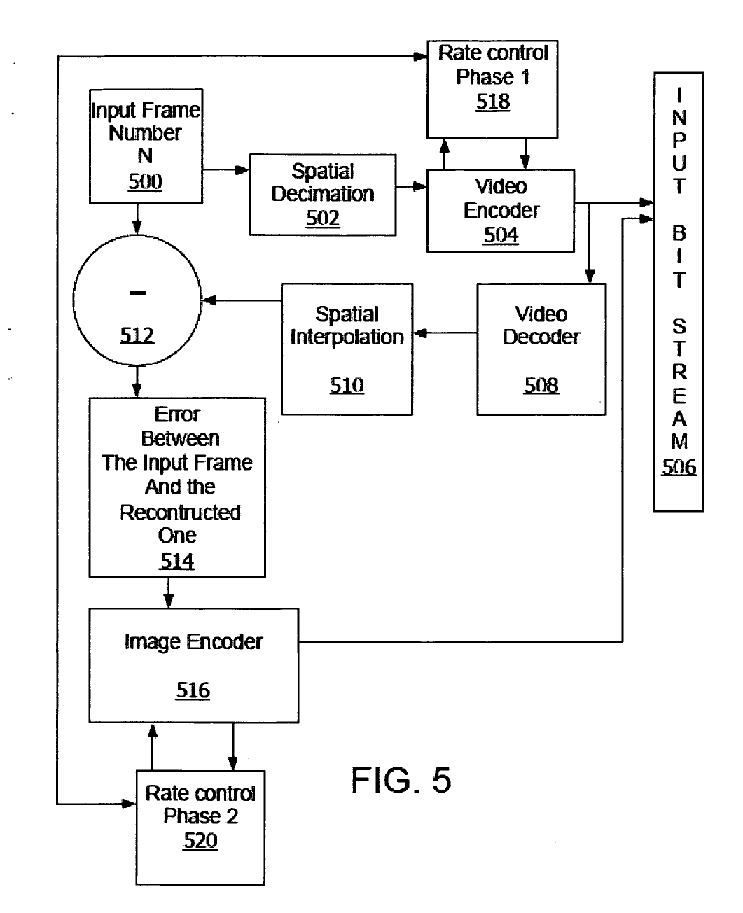

Reference is now made to FIG. 5, which illustrates an exemplary procedure for such two dimensional-rate control over a frame or macro block. As discussed above. The procedure may use two rate control algorithms as before and dynamically select the rate for a given frame or macro-block as follows:

The first rate control (block 518 of FIG. 5), is responsible for the rate of the video encoder, the second rate control (block 504 of FIG. 5) is responsible for the rate of the image encoder (block 516 of FIG. 5).

For each rate control algorithm and for each frame or macro block the following may be carried out: Estimate the rate distortion characteristics of the Frame based on a) rate distortion statistics, b) GOP length and c) a Virtual Buffer Model management arrangement.

Find which of the rate control algorithms provide a quantization which is compliant with other rate-distortion characteristics.

Reference is now made to FIG. 7, which illustrates a more detailed embodiment of the two dimensional rate control decision according to the present embodiments. In FIG. 7, An input frame or field (700) is processed in units of a macro block.

In Inter mode, output of the optimizer (block 712) is used. The result of block 712 is formed by choosing from the output of the set of motion compensation algorithms in block 706 708 and 710. Block 706 708 and 710 carries out multiple motion compensation algorithms. The motion compensation algorithms may be different algorithms or may be the same motion compensation algorithm with different settings, For example the same algorithm may be used with different settings such as pixel precision, for example precisions set at a pixel, half pixel, quarter pixel or more. Likewise numerous motion compensation algorithms 706 708 and 710 may be used to form the prediction.

The result of the block 712 is the prediction that is subtracted from the current spatial decimation of the input frame (714) to produce a residual, that is transformed, using a block transform (716) and quantized (722) using the Master rate control decision algorithm (736) to give the quantization both for quantize block (730) and (722). The quantization may be defined by a set of quantized transform coefficients which are reordered and entropy encoded, designated as box 724. The entropy-encoded coefficients, together with side information required to decode each block within the macro block form the compressed bit stream which is passed to a Network Abstraction Layer (NAL) for transmission or storage. The side information may include prediction modes, quantized parameter, motion vector information, etc.

As well as encoding and transmitting each block in a macro block, the encoder decodes, or in other words reconstructs, the macro block to provide a reference 726. The coefficients are scaled (Q-1) in block 724 and inverse transformed (T-1) in block (738) to produce a reference frame (726). The prediction block 706, 708 and 710 create each one a reconstructed block (712). The block (712) reconstructed the frame and send it to the two dimensional spatial interpolation filter 718 that reconstruct reference frame to it's original size.

The output of block 718 is subtracted from the input frame (700) to produce a residual, that is transformed, using a block transform (720) and quantized (722) using the Master rate control decision algorithm (736) and then pass through the variable length (730).

The procedure may use two rate control algorithms, block 732 and 734, as before and dynamically select the rate for a given frame or macro-block as follows:

The first rate control, block 732, is responsible for the rate of the residual error between block 712 and block 714, the second rate control is responsible for the rate of the residual of block 700 and 718,

For each rate control algorithm and for each frame or macro block the following may be carried out: Estimate the rate distortion characteristics of the Frame based on a) rate distortion statistics, b) GOP length and c) a Virtual Buffer Model management arrangement.

Each rate control, 732 and 734, send a quantization which is compliant with other rate-distortion characteristics to the master rate control (736).

Each rate control 732 and 734, send their quantization and rate—distortion characteristics to the Master Rate control decision (736). The Master Rate control decision know the global quantization needed and divide the available amount of quantization between the two rate control, it send the appropriate quantization to each quantize module (722) and (730),

For the rate control decision for each frame or macro block the following may be carried out:

Estimate the rate distortion characteristics of the two Frame based on a) Global rate distortion statistics, b) GOP length and c) a Global Virtual Buffer Model management arrangement.

Any suitable method of motion estimation may be used in the present embodiments and the following is a partial list:

Block Matching.

Phase Correlation.

Pel-Recursive Methods.

(Netravali-Robbins, Walker-Rao, Wiener-estimation based).

The Horn-Schunck Algorithm.

Others (Nagel, Fogel, etc.).

Spatiotemporal Energy Methods.

Stochastic-Model Based Methods.

Full Search Motion Estimation.

Rate Distortion optimized Full Search Motion Estimation.

Alternate Pel Sub-sampling.

Three Step Search.

Region Diamond Search.

Hierarchical Motion Estimation.

Zero Motion Vector.

RBMAD & Full Search.

MME & Full Search.

PDC & Full Search.

DPC & Full Search.

BBM & Full Search.

Integral Projection Matching.

The following is a partial list of different motion compensation algorithms that may be considered in the present embodiments:

Block motion compensation.

Variable block-size motion compensation.

Overlapped block motion compensation.

Quarter Pixel (QPel) and Half Pixel motion compensation.

Fixed Size Block-Matching (FSBM).

Variable Size Block-Matching (VSBM)

Object based block-matching motion compensation

Fixed Size Block-Matching (FSBM)

Variable Size Block-Matching (VSBM).

The following is a non-comprehensive list of rate control algorithms that may be used in the present embodiments:

MPEG Test Model 5 Algorithm.

Delayed-Decision Bit-Rate Control.

Lagrange Multiplier Techniques.

Trellis-Based Techniques.

Techniques for Dependent Quantization.

Approximation Models for Rate and Distortion Functions.

Statistical Model for Gaussian Source.

Exponential Model.

Bit-Rate Control Using Gradient Search 47.

Solution Using Gradient Search Techniques.

Penalty Functions.

Iterative Gradient Search.

Integer Approximation.

Initialization.

Approximation of Rate-Distortion Functions.

Spline Approximation Method.

Compliance Test for Intra-Frame Approximation.

Application to Local Adaptive Quantization.

Inter-Frame Dependency Model.

R-D Model of Predictive Frames.

Bit-Rate Control with Approximated R-D.

Revised Gradient-Based Algorithm.

Fast Bit-Rate Control Schemes.

Fast Bit-Rate Control with Predicted R-D.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A computerized method for encoding video comprising:
dividing a video frame into macro-blocks; Re-size the video frame into a lower resolution and Divide the resized video frame into macro-blocks Encode the resized frame with video encoder.
The video encoder include a set of motion compensation algorithms that are connected to the same motion estimation block.
Find the optimal motion compensation algorithm for each macro-block from a set of motion compensation algorithms. The chosen motion estimation algorithm for each macro-block gives the minimal error compared with the reference resized frame.
Resizing the output macro-block of the chosen motion compensation algorithm to the original frame size and subtract it from the original macro-block.
Encoding the result with a still image encoder.
Performing a two stage rate control process, the first rate control phase work on the video encoder scope, and a second rate control phase work on the image encoder scope, The data received from the two mentioned above independent rate control processes are transmitted to a master a rate control processor that set the quantization factor for each rate control process. The master rate control give two dimension quantization, one quantization factors to the video encoder and one quantization factors to the image encoder respectively.
According to the present embodiments allows for dynamic switching between pairs of two dimensional decimation and interpolation algorithms.

2. The method of claim 1, further comprising finding the optimal motion compensation algorithm from a set of different motion compensation algorithms.

3. The method of claim 1, further comprising finding the optimal motion compensation algorithm from a set of same motion compensation algorithms with different settings.

4. The method of claim 1, comprising two rate control that performing a two stage rate control process, the first rate control phase work on the video encoder scope, a second rate control phase work on the image encoder scope, The data received from the two mentioned above independent rate control processes are transmitted to a master a rate control processor that set the quantization factor for each rate control process. Eventually, the master rate control give two dimension quantization factors.

5. The method of claim 1, finding an optimal spatial decimation/interpolation filter algorithm pair, comprises of running each one of a plurality of the spatial decimation/interpolation filter algorithm pairs on the macro-block, measuring an error for each pair and selecting the pair giving the smallest error.

6. The method of claim 1, comprising A motion compensation algorithm that is selected dynamically for encoding individual macro-blocks of an image. The selection is made by using concurrently multiple motion compensation algorithms to encode the macro-block. An error is found in each case between the resize source macro-block and the set of reconstructed macro-blocks from the set of motion compensation algorithms that run concurrently and choosing the motion compensation algorithm that produces the smallest error is selected for that macro-block

7. The method of claim 1, The video encoder include a set of motion compensation algorithms that are connected to the same motion estimation.

8. The method of claim 1, Resizing the output macro-block of the chosen motion compensation algorithm to the original frame size and subtract it from the original macro-block. Encoding the result with a still image encoder.

9. The decoder is able to switch between different motion compensation algorithms based on information sent by the encoder.

10. The decoder is able to switch between different types of two dimensional interpolation algorithms and motion compensation algorithms based on information sent by the encoder.
